(19) United States
(12) Patent Application Publication
(10) Pub. No.: US 2014/0139010 A1
(43) Pub. Date: May 22, 2014

(54) SAND WHEEL

(71) Applicant: Dale Lewis Brown, Montgomery, AL (US)

(72) Inventor: Dale Lewis Brown, Montgomery, AL (US)

(21) Appl. No.: 13/679,682

(22) Filed: Nov. 16, 2012

(51) Int. Cl. B60B 15/00

(52) U.S. Cl. CPC B60B 15/00
USPC 301/53

(57) ABSTRACT

A wheel for use on soft granualar surfaces has a circumference having a plurality of concave cavities facing radially outwardly therefrom. The wheel may be used in combination with a cart, dolly, trailer, vehicle or the like.

### FIELD OF THE INVENTION

The present invention relates to a wheel for use on soft, granular surfaces. The wheel is particularly well adapted to enable a cart to roll over dry, fine, loose sand.

### BACKGROUND OF THE INVENTION

Soft, dry, granular surfaces, such as loose dry sand surfaces, pose problems to carts, trailers, dollies and motor vehicles having conventional wheels. Conventional wheels tend to “dig in” or “trench” and lose traction when rolling over such surfaces. Conventional wheels tend to displace sand outwardly and forwardly thus causing a “trenching” and/or “digging in” effect in soft dry sand. This results in the wheel increasingly pushing sand granules ahead of itself, ultimately causing resistance to the point that progress is halted. Attempts to overcome this effect have usually involved increasing the surface area in contact with the soft surface to reduce the weight per square inch that is supported by the wheel or providing ribs or other traction increasing features on the wheel's circumference.

Of course, problems traveling over soft surfaces have been known for many years and there have been efforts in the past to develop improved tires or wheels for use on soft surfaces. For example, U.S. Pat. No. 5,580,074 which issued Dec. 3, 1996 to Moreno for WHEEL SYSTEM FOR SOFT SURFACES, teaches a platform or cart with a multitude of generally spherical rollers arrayed across most of the bottom of the cart so as to provide low resistance passage over soft or sandy surfaces. Another example of past efforts is a wheel with improved traction shown in U.S. Pat. No. 1,297,631, which issued Mar. 18, 1919 to Allen for TRACTOR WHEEL,

However, despite past efforts, there remains a need for an improved wheel for use on soft, dry granular surfaces. In particular, there is a need for design that reduces the tendency of the wheel to “dig in” or “trench” and which facilitates rolling of the wheel over the soft, dry, granular surface. Accordingly the present invention provides a wheel particularly well adapted for use to support a cart or the like on soft dry surfaces such as loose sand.

In accordance with the present invention, a wheel is provided which sequentially displaces dry sand granules radially inwardly and upwardly into a plurality of concave cavities or hollow spaces located in the circumference of the wheel, in effect, compressing the dry grains of sand into the cavities along the circumference of the wheel to allow the wheel to continue to roll over the sandy surface. Each concave cavity of the wheel is able to collect sand over which it rolls and compress the sand grains in the cavity. Once the cavity of the wheel has rolled over the sand, the sand granules fall from the concave cavity back to the sandy surface.

Further understanding of the present invention will be had from the following description and claims taken in conjunction with the accompanying drawings.

### BRIEF DESCRIPTION OF THE DRAWINGS

FIG. 1 is a perspective view of a preferred embodiment of a wheel of the present invention;

FIG. 2 is a side elevation view, partially broken away, of the preferred embodiment of FIG. 1 shown in use on soft sand and in combination with a cart, broken away;

FIGS. 3a-3d are somewhat schematic views illustrating the steps of using a wheel of FIG. 1 to roll over soft sand;

FIG. 4 is a cross-sectional view of a spoke with a concave cavity for use in an alternative preferred embodiment of a wheel of the present invention.

FIG. 5 is a perspective view of an alternative preferred embodiment of a wheel of the present invention;

FIG. 6 is a side elevation view of the preferred embodiment shown in FIG. 5;

FIG. 7 is a sectional view taken along line 7-7 in FIG. 6;

FIG. 8 is a side elevation view similar to FIG. 6 but showing yet another preferred embodiment of a wheel of the present invention; and

FIG. 9 is a sectional view taken along line 9-9 in FIG. 8.

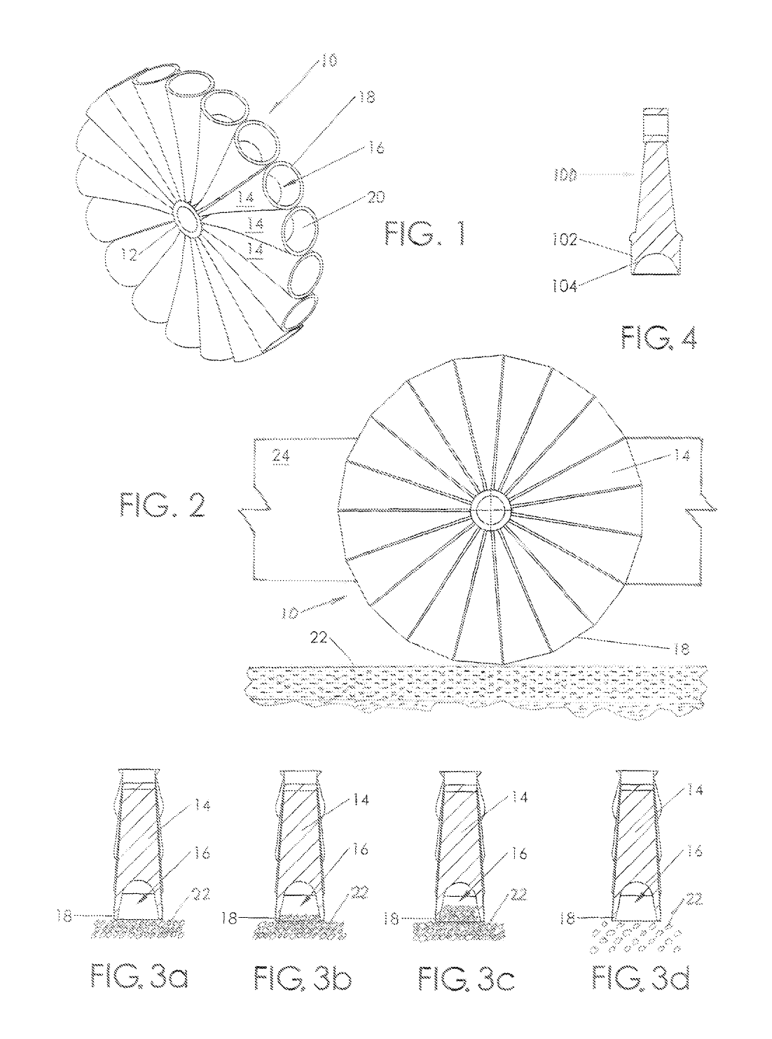

### SUMMARY OF THE INVENTION

A wheel for use on soft, granular surfaces, such as fine, dry, loose sand, has a circumference having a plurality of concave cavities facing radially outwardly therefrom. The wheel is particularly well suited for use in combination with a cart, dolly, trailer, vehicle or the like.

### DESCRIPTION OF THE INVENTION

The problem posed by soft dry sand to carts, dollies, trailers or other vehicles is well known. Their wheels tend to sink down into the sand, especially if the associated cart, dolly, trailer or vehicle is carrying a heavy load. Conventional attempts to overcome this problem generally involve the use of tracks or oversized wheels to provide large surface areas contacting the sand in an attempt to preclude their digging in or trenching in the soft surface. While such large tires or tracks enjoy some success in traversing soft materials, there is an expense associated with their increased size and in many cases the vehicle or cart which they are supporting must be modified to accommodate their large size. Thus, there remains a need for an improved wheel for use on soft sand.

Broadly speaking, the present invention provides a wheel having a plurality of concave cavities about its circumference. When rolling on a soft, sand surface, sand grains are displaced into each concavity upwardly and towards each other in compacting fashion thereby themselves providing support for the wheel and allowing the wheel to roll over the sand.

The wheel of this invention is described in the context of its use on soft sand surfaces. However, it will be appreciated by those skilled in the art that the wheel is well adapted for use on other soft surfaces and such uses are contemplated to be within the broad scope of the present invention.

Now referring to FIG. 1, a preferred embodiment of a sand wheel of the present invention is shown and indicated generally by the numeral 10. Sand wheel 10 has a hub 12 for mounting on an axle of a cart, trailer, vehicle or the like. Sand wheel 10 comprises a plurality of conically shaped members 14 which are welded, molded with, or otherwise secured to each other to form wheel 10. Each conical member 14 has a radially outwardly open concave cavity, or concavity, 16 and an outwardly facing edge 18. Each outwardly facing concavity 16 is defined by inner surface 20 which is radially inwardly tapered and is of a radially inward depth sufficient to compress soft sand granules forced into concavity 16 to enable wheel 10 to roll over a sand surface. The radially outwardly facing edges 18 of conical members 14 combine to form the circumference of wheel 10. Edges 18 are illustrated herein as circular and are intended to confine sand grains within their boundaries to guide the confined sand grains upwardly into the associated concavity 16 when in use. Of course, edges 18 may alternatively be elliptical or of any other suitable shape so long as they function in accordance with the present invention. Each edge 18 defines the radially outwardly opening of each concavity 16. Further understanding of the present invention and its function can be had from the following description of the operation of wheel 10.

In operation, wheel 10 performs as illustrated in FIGS. 3a, 3b, 3c, and 3d. These figures illustrate how sand granules 22 are captured and compressed into concavity 16 during rotation of wheel 10.

FIG. 3a shows conical member 14 with edge 18 just coming into initial contact with sand granules 22 as wheel 10 is rotating. Concavity 16 is empty of sand granules 22 as edge 18 has just come into contact with the sand surface.

FIG. 3b shows conical member 14 of wheel 10 at a point in time just after FIG. 3a. At the point in time illustrated in FIG. 3b, edge 18 has sunk somewhat down into the sand surface and some sand granules 22 have been confined by edge 18 and have moved upwardly into concavity 16.

FIG. 3c shows conical member 14 of wheel 10 at a point in time just after that of FIG. 3b. Now edge 18 of conical member 14 has sunk further into the sand surface and more sand granules 22 have moved upwardly into concavity 16 to be compressed by radially narrowing interior surface 20 of concavity 16. A sufficient quantity of sand granules 22 have been compressed into concavity 16 so that the downward force exerted by conical member 14 against the associated sand surface is equally opposed by granules 22 and edge 18 of conical member 14 to thereby support wheel 10 on the sand surface, or slightly below the sand surface. Thus, conical member 14 does not sink further into the sand.

Finally, as illustrated in FIG. 3d, upon further rotation of wheel 10, conical member 14 comes out of contact with the sand surface and granules 22 may drop away from concavity 16 due to the force of gravity.

Now referring to FIG. 4, a spoke for a wheel of an alternative preferred embodiment of the present invention is shown and indicated generally by the numeral 100. Spoke 100 has a distal end portion 102 molded or otherwise shaped to form concave cavity or concavity 104 which is analogous to concavity 16 described above. It will be appreciated by those skilled in the art that a plurality of spokes 100 can be secured to a hub or the like with distal ends facing radially outwardly to provide the circumference of a wheel of the present invention,

Now referring to FIG. 5, an alternative preferred embodiment of a sand wheel of the present invention is shown and indicated generally by the numeral 200. Sand wheel 200 has a hub 212 for mounting on an axle of a cart, trailer, vehicle or the like. Sand wheel 200 comprises a plurality of conically shaped members 214 which are bonded into a circumference 215 made of rubber. The combination of conically shaped members 214 and rubber circumference 215 form wheel 200. Analogous to conical members 14, each conical member 214 presents a radially outwardly open concave cavity, or concavity, 216 and an outwardly facing edge 218. Each outwardly facing concavity 216 is defined by inner surface 220 which is radially inwardly tapered and is of a radially inward depth sufficient to compress soft sand granules forced into concavity 216 to enable wheel 200 to roll over a sand surface. The radially outwardly facing edges 218 of conical members 14 combine to form the outer circumference of wheel 200.

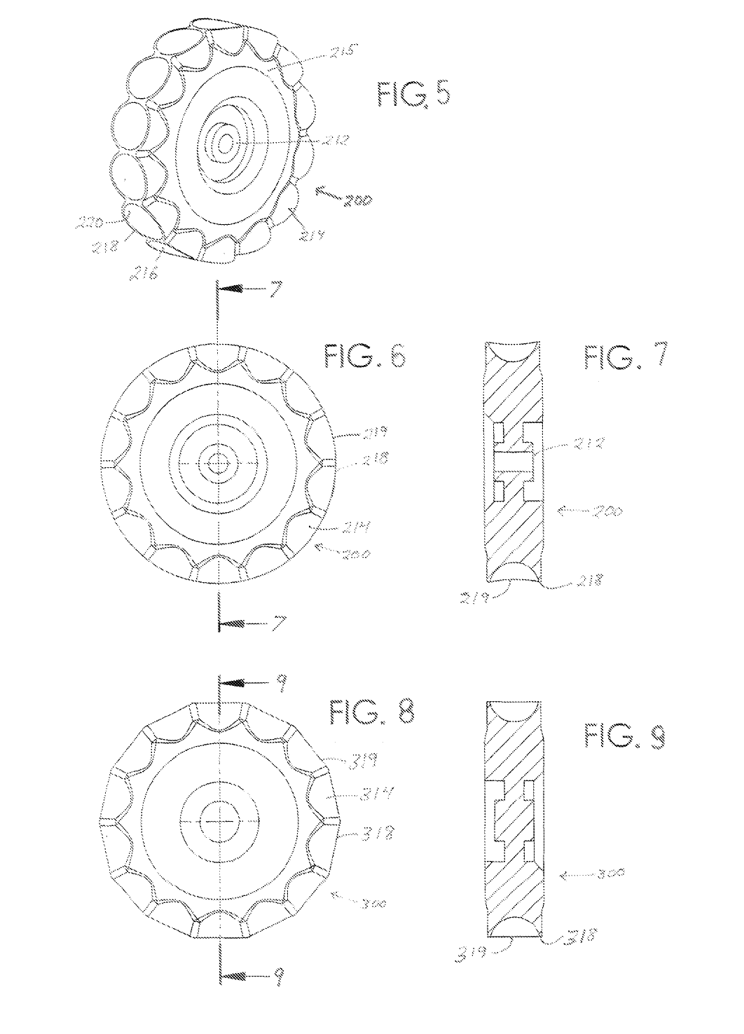

Edges 218 are best shown in FIGS. 6 and 7 which illustrate that the outer circumference 219 of wheel 200 is circular so that wheel 200 will roll smoothly over a hard surface. Thus, points on each edge 218 of each conical member 214 do not lie on a plane but are equidistant from the center of wheel 200.

Referring to FIGS. 8 and 9 still another variation of a preferred embodiment of the present invention is shown and indicated generally by the numeral 300. Sand wheel 300 is analogous to sand wheel 200 except that sand wheel 300 has conically shaped members 314 which present outwardly facing edges 318 which differ from edges 218 of wheel 200 in that each edge 318 is planar such that outer circumference 319 of wheel 300 is not perfectly round. This arrangement of conically shaped members 314 with planar outer edges 318 will detract from wheel 300 rolling smoothly over a smooth hard surface but will present outward openings of concavities 316 to granular sand surfaces in an advantageous manner.

It will be appreciated by those skilled in the art that the present invention is subject to modification and variation and it is intended that such modifications and variations are considered to be within the broad scope of the invention which is intended to be limited only by the following claims. For example, the present invention may be modified by having concavities of a different shape or configuration than that shown in the figures such as by having edges which are elliptical rather than circular in configuration. Such modifications are intended to be included herein so long as they operate in accordance with the principles of this invention.

What is claimed is:

1. A wheel for use on a soft granular surface, said wheel having a circumference with a plurality of radially outwardly facing concavities, each of said concavities having a radially outwardly facing edge adapted to sequentially capture and confine granules radially inwardly and upwardly into the associated concavity compress the granules into the concavity to allow the wheel to continue to roll over the surface.

2. A wheel as in claim 1 wherein each of said edges is circular.

3. A wheel as in claim 1 wherein each of said edges is elliptical.

4. A wheel as in claim I wherein each of said edges is polygonal.

5. A wheel as in claim 1 wherein each of said concavities is defined by an inwardly facing surface of a conical member.

6. A wheel as in claim 5 having a plurality of said conical members.

7. A wheel as in claim 1 wherein said cavities are formed in a unitary manner with said wheel.

8. A wheel in combination with a cart, said wheel having a circumference having a plurality of concave cavities facing radially outwardly therefrom.

9. A wheel as in claim 1, wherein said wheel has a plurality of conical members bonded into a rubber circumference.

10. A wheel as in claim 9 wherein each of said conical members has an outwardly facing edge which is planar.

11. A wheel as in claim 9 having a radial center and wherein each of said conical members has an outwardly facing edge which is radially equidistant from said center.

12. A method of supporting a wheel on a soft granular surface, the method comprising the steps of: providing a wheel having a circumference with a plurality of radially outwardly facing concavities, each of said concavities having a radially outwardly facing edge; sequentially contacting each of said edges with said granular surface to at least partially fill each of said concavities with granules in compression to thereby support said wheel on said surface.
